(19) United States
(12) Patent Application Publication
(10) Pub. No.: US 2023/0249195 A1
(43) Pub. Date: Aug. 10, 2023

(54) AIR PURIFICATION UNIT AND METHOD FOR COATING AN ELECTRODE OF AN AIR PURIFICATION UNIT

(71) Applicant: DORNIER NEW TECHNOLOGIES GMBH, Rietberg (DE)

(72) Inventors: Johannes Pradler, Angeles City (PH); Iren Dornier, Munich (DE); Wolfgang Wagner, Friedrichshafen (DE)

(21) Appl. No.: 18/102,745

(22) Filed: Jan. 29, 2023

Related U.S. Application Data
(63) Continuation of application No. PCT/EP2021/072053, filed on Aug. 6, 2021.

(30) Foreign Application Priority Data
Aug. 20, 2020 (DE) DE102020121872.9
Aug. 21, 2020 (DE) DE102020121987.3

(51) Int. Cl. B03C 3/019; B01D 46/00; B01D 46/24; B03C 3/08; B03C 3/68; B03C 3/60; B03C 3/82; B01D 53/88

(52) U.S. Cl. CPC B03C 3/019; B01D 46/0032; B01D 46/24; B03C 3/08; B03C 3/68; B03C 3/60; B03C 3/82; B01D 53/885; B01D 2279/50; B01D 2259/4575; B01D 2257/708; B01D 2255/20707

(57) ABSTRACT

An air purification unit including an electric filter module through which air to be purified can flow and a first electrode and a second electrode between which the air to be purified flows and between which a first electric field can be generated by applying an electric high voltage provided by a power supply module, wherein the first electrode and the second electrode form an ionizer and wherein a mechanical filter module with a mechanical filter element is arranged downstream of the electric filter module in the direction of flow of the air to be purified, wherein a third electrode is provided in the mechanical filter element or in the mechanical filter module downstream of the mechanical filter element, and wherein a second electric field can be generated between the second electrode and the third electrode by applying an electric voltage.

### RELATED APPLICATIONS

This application is a continuation of International application PCT/EP2021072053 that claims priority from German patent applications DE 10 2020 121 872.9 filed on Aug. 20, 2020 and DE 10 2020 121 987.3 filed on Aug. 21, 2020, all of which are incorporated in their entirety by this reference.

### FIELD OF THE INVENTION

The present invention relates to an air purification unit. In particular, the invention relates to an air purification unit for use in a mobile air purification unit, in a stationary air purification unit or in a vehicle, and most particularly for use in an aircraft. It further relates to a method for coating an electrode of the air purification unit.

### BACKGROUND OF THE INVENTION

There are a variety of air purification devices of different designs. Simple filter systems work with so-called HEPA filters to effectively filter out particles with sizes down to approximately 0.1-0.3 μm. In addition, there are electrical filtering devices, so-called air ionizers, which produce ions that attach to micro-particles or destroy particles and odors by generating micro-oxidation in the immediate vicinity of the ionization processes. In many cases, so-called ionization tubes are used or corona discharges are generated at special electrodes. In the designs commonly used to date, ionization is generated by thin wires spanned in the air stream. In some cases, plate arrays or tube systems are also used. However, in particular plate ionizers are designed for a size of several meters plate length and plate spacing of several centimeters. As a result, plate ionizers cannot currently be incorporated into existing air-conditioning systems, particularly in commercial aircraft, because the design and relative dimensions of plate size and plate spacing do not accommodate the tight construction conditions in a vehicle, especially in an aircraft. In addition, very high electrical voltages of 20 kV to 70kV must be used. Ionizers with wires have the disadvantage that, due to the system, they only produce effective ionization in the direct vicinity of the wire due to the constriction of the field lines that occurs there, and thus only function effectively at low air velocities, which makes them less suitable for use in vehicles where high air flow rates are required.

Electrostatic filters are known from U.S. Pat. No. 4,056,372 A. These electrostatic filters also generate ions that adhere to contaminants and are then deposited and collected on a cathode. There are various further developments in this regard, in which the cathodes are surrounded with porous materials to prevent the adhering dirt particles from falling off later (US 2016/0074877 A1). A combination of these further developments is shown and described in U.S. Pat. No. 5,330,559 A, according to which air is first ionized (for example with ionization tubes) and the particles are then collected in electrostatic filters equipped with a cathode in the form of metal grids.

U.S. Pat. No. 5,330,559 A describes an electrostatic air cleaning device with plate-shaped filters or as a cylindrical round filter. Here, the air first flows through an ionizing device which has a plurality of negative electrode plates arranged parallel to one another and a plurality of positive electrode wires arranged between two electrode plates in each case. A high voltage of 6 to 20 kV DC is present between these electrodes. Downstream of the ionizing device is a filter package consisting of a ground grid, a filter medium following in the direction of flow, a semiconductor grid following on from this, a further filter medium and a downstream ground grid, which are assembled to form a compact air purification unit. The semiconductor grid is connected to a negative high voltage of approximately 12 to 45 kV DC and the two ground grids are each connected to ground. Dust particles present in the air are positively electrically charged in the ionizing device, and these are then separated in the filter device, with a high gradient electric field being generated by the negatively fed semiconductor grid and the ground grids. This air cleaning device thus has two electrostatic field generators, firstly the ionizing device with the ground grid downstream of it in the direction of flow of the air, and then the negative high-voltage electrode located inside the filter arrangement with the ground potential grid downstream of it in the direction of flow. The ground grid is arranged upstream of the mechanical filter elements.

WO 2008/083 076 A2 shows and describes a two-stage filter device with an ionizer mounted between two mechanical filters, the central ionization electrode being formed by a corona wire. A further electrode is mounted in front of the first filter or behind the second filter, between which and the corona wire an electrostatic field is built up in each case. In addition, another field electrode can be provided between the corona wire and the respective mechanical filter. The filter arrangement can also be designed as an annular cylindrical filter.

U.S. Pat. No. 8,167,984 B1 shows and describes a multi-stage electrostatic agglomeration device for removing particles from an air stream. A plurality of electrostatic devices are spaced one behind the other in the direction of air flow. Each of these electrostatic devices has a plurality of plate electrodes extending in the direction of flow, so that the air flows between the plate electrodes. A mechanical filter is arranged between each two adjacent electrostatic devices arranged one behind the other.

US 2005/0109204 A1 shows and describes an air filter unit equipped with an electrostatic precipitator, in which an ion generator is provided upstream of a mechanical filter medium with a first electrode having several rows of corona discharge wires and a second electrode provided upstream of the mechanical filter unit, and wherein a third electrode connected to electrical ground is provided downstream of the mechanical filter unit in the direction of air flow. A voltage of 10 to 15 kV is applied between the first electrode having the corona wires and the ground. The voltage drop between the second electrode and the third electrode generates an electric field which polarizes the fibers in the mechanical filter so that particles with opposite electric charges are electrostatically attracted to the filter fibers.

DE 3 502 148 C2 shows and describes an electrostatic air cleaner in which air is first passed through a prefilter followed by a corona discharging device. Downstream of the corona discharging device is a dust collecting device which has a plurality of dust collecting electrodes between which the air to be purified flows. A deodorizing filter loaded with activated carbon is provided downstream of the dust collection device.

U.S. Pat. No. 9,468,935 B2 shows and describes an air filter system with an electrostatic precipitator module, which has a first electrode grid through which the air initially flows, as well as a second electrode grid, a mechanical filter element arranged downstream thereof, and a third electrode grid arranged downstream thereof. While the first electrode grid is connected to a negative high voltage and the third electrode grid is connected to a positive high voltage, the second electrode grid is connected to ground.

JP 6 290 891 B2 shows and describes an air purifier having two stages through which the air to be purified flows in succession, namely an ionization stage and an electrostatic dust collection stage. The ionization stage has a plurality of plate electrodes in contact with the ground, between each of which is arranged a discharge electrode formed by a corona wire. The dust collection stage has a dust collection filter in front of which a discharge electrode having a plurality of corona wires arranged side by side is provided, and behind which a ground electrode is provided. The dust collection stage and the ionization stage are each coupled to their own power supply. An electrode arranged behind the mechanical filter element interacts electrically with the corona wire grid of the discharge electrode of the dust collection stage independently provided by the ionization module.

U.S. Pat. No. 4,056,372 A shows an arrangement of electrode plates in which positive electrode plates and negative electrode plates are arranged alternately in parallel and the air flows through the spaces formed between the plates. The positive electrode plates are provided with needle tips as discharge electrodes at their front and rear edges in the flow directions.

### BRIEF SUMMARY OF THE INVENTION

The object of the present invention is to improve a generic air purification unit having at least one electric filter module through which air to be purified can flow, so that it can be integrated into existing air-conditioning systems with a compact design and filters out particles down to particle sizes of less than 0.1 μm, in particular for sustained effective use against biological air pollutants, for example viruses. Furthermore, a method for coating the electrode(s) of an electric filter module used therein is to be specified. The part of the object directed to the air purification unit is solved by an air purification unit having the features of claim 1.

An air purification unit with at least one electric filter module through which air to be purified can flow and which has at least one first electrode and at least one second electrode between which the air to be purified flows and between which a first electric field can be generated by applying an electric high voltage provided by a power supply module, wherein the at least one first electrode and the at least one second electrode form an ionizer and wherein a mechanical filter module with at least one mechanical filter element is arranged downstream of the electric filter module in the direction of flow of the air to be purified, is characterized in that at least one third electrode is provided in the mechanical filter element or in the mechanical filter module downstream of the mechanical filter element, wherein a second electric field can be generated between the at least one second electrode and the at least one third electrode by applying an electric voltage. The voltage applied between the at least one first electrode (anode) and the at least one second electrode (cathode) is preferably a DC voltage that is between 3 kV (3,000 volts) and 10 kV (10,000 volts), preferably between 5 kV and 10 kV. The potential of the at least one second electrode, i.e., the cathode, is in the range of 10% to 20%, preferably 15%, of the high voltage applied to the at least one first electrode, i.e., the anode, relative to the system ground, for example 1,000 V.

### Advantages

The electric filter module of the air purification unit according to the invention forms a two-stage electric filter whose first stage, comprising the at least one first electrode (anode) and the at least one second electrode (cathode), forms an ionizer which generates a cold plasma. A cold plasma, which is also referred to as a non-thermal plasma, has a significant difference in terms of electron temperature and gas temperature from a conventional hot plasma, such as that generated in an electric arc. For example, the electron temperature in a cold plasma can be several 10,000 K, corresponding to average kinetic energies of more than 1 eV, while the gas temperature corresponds to ambient temperature (for example, room temperature). Such non-thermal plasmas can trigger chemical reactions via electron collisions despite their low gas temperature.

In the electric filter module according to the invention, an electric field is built up in the first electric filter stage forming an ionization stage between the at least one first electrode and the at least one second electrode, which generates a non-thermal plasma at atmospheric pressure in the air flowing through the electrodes. In this process, electrons originating from ionization processes are accelerated in such a way that they trigger impact ionization processes. When the electrons collide with other gas atoms or molecules contained in the air (for example, biological or chemical pollutants), they can transfer their energy to them and thus destroy them. The electron energy is sufficient to break covalent bonds in organic molecules.

The second electric filter stage is formed by the at least one second electrode and the at least one third electrode. In the second electric filter stage, at least one mechanical filter element of the mechanical filter module is designed as a particle or particulate filter, for example as a HEPA filter, or is at least partially integrated therein.

Two different electric fields are thus generated in the electric filter module with three electrodes or groups of electrodes. The first electric field generated in the first stage, the ionization stage, between the at least one first electrode (anode) and the at least one second electrode (cathode) generates the cold plasma in the air flowing through, which causes the biological air pollutants to be killed or inactivated, while the second stage accelerates the particles contained in the air, for example the killed or inactivated biological air pollutants (viruses, bacteria, fungi), in the direction of the mechanical filter element and separates them there. Thus, within the second electric filter stage, a second electric field is established between the at least one second electrode and the at least one third electrode, which causes the previously charged particles from the ionizer to be accelerated towards the mechanical filter, where they are collected in the filter material. The invention implements an efficient ionizer that can be operated at relatively lower high voltage to emit less electromagnetic interference even in EMC-sensitive environments, especially in commercial aircraft.

Further advantageous design features of the air purification unit according to the invention are the subject of the dependent claims.

Advantageously, the at least one first electrode (anode) and the at least one second electrode (cathode) are designed as plate electrodes. The design of the electrodes of the ionization stage as plate electrodes provides a large-area expansion of the electric field extending over the mutually facing surfaces of the plate electrodes simultaneously with large air throughput. In particular, if a plurality of first electrodes and a plurality of second electrodes arranged alternately next to each other form a stack of plate electrodes, a large cross-sectional area through which the air to be purified can flow is created. As a result, a high air flow rate is achieved with a compact structure of the air purification unit. The distance of the adjacent plate electrodes from each other (width of the plate gap) is advantageously selected so that an electric field strength of at least 650 kV/m, advantageously up to 900 kV/m, is established between the two adjacent plate electrodes. The height of the plate electrodes, i.e. the height of the respective plate gap, and the number of plate electrode pairs of the ionization stage, i.e. the number of plate gaps, together form the free cross-sectional area of the first electric filter stage, which is determined as required on the basis of the size of the air stream to be purified (in volume units per unit time) and the flow velocity of the air.

The length of the plate electrodes and thus of the respective plate gap in the direction of flow is advantageously dimensioned in such a way that, at maximum flow velocity, the free electrons formed in the ionization stage do not flow out of the static electric field between the plate electrodes, but travel as long a distance as possible between the plate electrodes in order to trigger impact reactions there, which leads to increased ionization efficiency. An advantageous flow velocity of the air through the ionizer is maximum 1.75 m/s. An exemplary migration distance of the electrons at a given flow velocity is a maximum of 20% of the length of the respective plate electrode (measured in the direction of flow).

In another exemplary embodiment, the surfaces of the at least one first electrode and/or the at least one second electrode are provided, at least in some areas, with a catalytic surface layer comprising a titanium oxide, advantageously in the form of titanium oxide nanoparticles, for example titanium dioxide nanoparticles, these nanoparticles advantageously being smaller than 50 μm in diameter. Advantageously, the surfaces of both the first electrode and the second electrode are provided with this coating, although in a modified embodiment of the invention the coating may also be provided only on the surface of one of the two electrodes of a pair of electrodes, for example on the surface of the cathode.

Such a surface layer causes the cold plasma formed between the first and second electrodes to break down volatile hydrocarbons and hydrocarbon compounds (so-called VOCs—volatile organic compounds) and decompose them into shorter-chain hydrocarbon compounds, thus decomposing VOCs contained in the air. It is advantageous if the catalytic surface layer is formed from titanium isopropoxide (C₁₂H₂₈O₄Ti) with titanium oxide nanoparticles, for example titanium dioxide (TiO₂).

It is also advantageous to have an embodiment of the invention which can be combined with other embodiments, in which the at least one first electrode (anode), which is in the form of a plate electrode, is shorter in the direction of flow of the air to be purified than the at least one second electrode (cathode), which is also in the form of a plate electrode, the at least one second electrode protruding beyond the at least one first electrode in the downstream direction and/or in the upstream direction.

Advantageously, in one embodiment of the invention which can be combined with other embodiments, the at least one first electrode, i.e. the anode, has a (advantageously central) plate section which is provided with at least one electrically conductive needle extension which is located essentially in the plate plane of the plate section and which extends in the downstream direction and/or in the upstream direction beyond the plate edge of the plate section of the first electrode. Thereby, the tip angle α of the needle extension advantageously lies in a range between 15° and 45°, further advantageously between 20° and 40° and particularly advantageously it is 39°. Advantageously, the respective needle extension is integrally formed with the respective plate section of the plate electrode and therefore may be made of the same material as the plate section. Advantageously, several such needle extensions are provided next to each other at the downstream edge and/or at the upstream edge of the plate section of the anode.

It is particularly advantageous if the at least one needle extension, which advantageously has a rectangular cross-section, tapers towards the needle tip in two orthogonal planes. In this variant, the tip angle in the plane of the plate is advantageously in a range between 30° and 45°, and is advantageously 39° here as well. The tip angle in the plane perpendicular to the plate plane is preferably between 15° and 30° and is advantageously 20°.

Advantageously, the surfaces of the at least one needle extension are not provided with the catalytic surface layer; consequently, the surface of the anode is provided with the catalytic surface layer only in the region of the plate section.

According to an exemplary embodiment of the invention, which can be combined with other embodiments, the at least one third electrode, which is advantageously designed as a grid electrode, is connected to the electrical ground and electrically positive voltage measured against ground is applied to both the at least one first electrode and the at least one second electrode, the positive voltage at the at least one first electrode being higher than the positive voltage at the at least one second electrode. The potential difference between the at least one cathodic electrode of the electrode pair of the first electric filter stage including or consisting of the at least one first electrode and the at least one second electrode and the negative (at least one third) electrode in or downstream the mechanical filter element is between 1.5 kV and 2.5 kV, this electrical voltage being in the range between 25% and 35% of the voltage in the first electric filter stage, i.e. the ionization stage.

According to a further advantageous embodiment of the invention, which can also be combined with other embodiments, the at least one third electrode is tubular in shape and is arranged in a tubular air outlet channel of the ring-cylindrical mechanical filter element.

According to yet another advantageous embodiment of the invention, which can be combined with other embodiments, a controllable DC voltage is applied during operation between the at least one first electrode and the at least one second electrode, and a constant DC voltage is applied during operation between the at least one second electrode and the at least one third electrode. The voltage level in the first electric filter stage is thus provided to be controllable and is dynamically controlled to a maximum voltage value by an electronic controller, taking into account measured variables such as anion quantity, ozone content and flashover detection.

It is advantageous in all embodiments of the invention if at least one sensor for monitoring the ozone content of the air is provided downstream of the arrangement comprising the at least one first electrode and the at least one second electrode in the direction of flow of the air to be purified. Advantageously, by means of this sensor and a regulating and control device, the ozone content of the air emerging from this electrode arrangement is controlled to a minimum below a permissible ozone value in the breathing air by influencing the electrical voltage applied between the first electrode and the second electrode.

It is advantageous in all embodiments if the mechanical filter module, in particular the mechanical filter element, has at least one activated carbon layer or an activated carbon filter element. The activated carbon contained therein can absorb any ozone formed in the ionization stage and release it again after it has been converted into oxygen.

It is also advantageous if, in addition or alternatively, at least one sensor for monitoring the amount of anions is provided downstream of the arrangement comprising the at least one first electrode and the at least one second electrode in the direction of flow of the air to be purified. Advantageously, the intensity of the resulting cold plasma is controlled by means of this sensor and the regulating and control device by influencing the electrical voltage applied between the first electrode and the second electrode.

Finally, in all embodiments of the invention, it is advantageous if the level of the electrical voltage applied between the at least one first electrode and the at least one second electrode is dynamically determined by a closed-loop control. A regulating and control device provided for carrying out the control thereby detects voltage flashovers occurring between the electrodes by continuously measuring the electric voltage (U) applied to the electrodes and the electric current (I) flowing between the electrodes of the first stage (ionization stage) and forming a value for the rate of change of current dl/dt in the regulating and control device. If this value exceeds a predetermined threshold value dlₘₐₓ/dt, the electrical voltage (U) is slightly reduced until the measured rate of current change is again just below the predetermined threshold value. In this way, the regulating and control device always generates the highest possible electric field between the electrodes in the ionization stage, i.e., a maximum electromagnetic field, without causing a significant number of voltage flashovers and thus the formation of arcs between the electrodes of the ionization stage. For example, up to 0.5 voltage flashovers per second is accepted as a limit value and above that the voltage is regulated down. Another control criterion is preferably the ratio of the actual electrical voltage applied to the electrodes of the ionization stage to a predetermined set voltage. If this ratio exceeds, for example, the value of +/−10% of the set voltage, the control intervenes. The above measures (individually or together) prevent the formation of a hot plasma in the air flowing through and ensure that only a cold plasma, i.e. a non-thermal plasma, is formed in the ionization stage.

An input variable for the control and regulation device is advantageously also the differential pressure prevailing between the air inlet and the air outlet of the mechanical filter module of the second electric filter stage.

Finally, in all embodiments of the air purification unit according to the invention, it is also advantageous if the electric filter module is surrounded by a shielding device and forms an electric filter unit therewith, at least one shielding module through which the air can flow being provided upstream and/or downstream of the electric filter module in the flow direction of the air to be purified, which has a multiplicity of air passage elements which each define an air passage channel surrounded by a channel wall, the flow-through shielding module having at least one honeycomb panel whose individual honeycombs are open at their two ends and each form one of the air passage channels, the respective channel wall being electrically conductive or having an electrically conductive surface. Such a shielding device shields the electric filter module such that no electromagnetic radiation can escape to the outside without substantially impeding the airflow passing through the electric filter module. Such EMC (electromagnetic compatibility) shielding may preferably be provided, for example, in vehicles, in particular in aircraft. A particularly advantageous embodiment is one in which such a flow-through shielding module is provided both on the air inlet side and on the air outlet side of the electric filter module.

Advantageously, the respective honeycomb panel consists of electrically non-conductive material, preferably paper, cardboard or a plastic, as a carrier material, the surface of which is provided with an electrically and/or magnetically conductive material at least in certain areas. Such a honeycomb panel is particularly light and therefore preferably suitable for use in an aircraft.

Furthermore, the invention is directed to an air purification system comprising an air purification unit according to the invention, in particular a vehicle interior air purification system, and to a ventilation and air conditioning system comprising such an air purification system, in particular for a vehicle or in a vehicle.

The invention is further directed to a vehicle, in particular to an aircraft, having at least one such air purification unit according to the invention.

Finally, the invention is also directed to a method for coating an electrode for an electric filter module of an air purification unit according to the invention with a catalytic surface layer comprising a titanium oxide, preferably titanium dioxide, comprising the steps of:

a) Providing a solution of titanium isopropoxide in isopropanol;

a′) Providing a suspension of titanium oxide nanoparticles, in particular titanium dioxide nanoparticles, in isopropanol and subjecting the suspension to ultrasonic vibrations;

b) Mixing the solution obtained in step a) with the suspension obtained in step a′) to form a suspension immersion bath;

c) Immersing the electrode to be coated into the suspension immersion bath for a predetermined immersion time period;

d) Pulling the coated electrode out of the suspension immersion bath;

e) Drying the coated electrode for a first predetermined drying period at room temperature;

f) Heating the coated electrode with a predetermined first heating temperature gradient up to an elevated drying temperature;

g) Drying the coated electrode for a second predetermined drying period at the elevated drying temperature;

h) Heating the coated electrode with a predetermined second heating temperature gradient to an input firing temperature;

i) Firing the coated electrode for a predetermined firing time period at a predetermined firing temperature; and

j) Cooling the fired coated electrode to room temperature for a specified cooling time period.

Advantageously, the electrodes to be coated are degreased and dried before immersion in the suspension immersion bath in step c) and heated to a temperature above 100° C., advantageously 105° C. The predetermined immersion time period in step c) is advantageously 5 minutes. During this immersion in step c) and before, the immersion bath is preferably subjected to ultrasonic vibrations in order to ensure—as in step a′)—a uniform distribution of the titanium oxide nanoparticles and to prevent agglomeration of the titanium oxide nanoparticles in the suspension. After the coated electrode has been withdrawn from the suspension immersion bath in step d), a step d′) is advantageously provided in which excess suspension can drip off the electrode; this drip-off period is advantageously 10 minutes. The first drying period for drying the coated electrode at room temperature in step e) is preferably 12 hours. Heating of the coated electrode in step f) is advantageously performed with a first heating temperature gradient of 3° C. per minute up to a drying temperature of 100° C. with a subsequent second drying time period of advantageously one hour in step g). Also, a second heating temperature gradient for heating the coated electrode up to the input firing temperature in step h) is advantageously 3° C. per minute up to the input firing temperature of advantageously 500° C. The firing temperature in step i) is advantageously 650° C. and the advantageous firing time is one hour.

It is particularly advantageous if steps c) to e) or c) to g) are carried out several times in succession—advantageously with cooling steps provided in between. This builds up a particularly effective catalytic layer on the electrode surface.

It is advantageous if diethanolamine is added to the solution of titanium isopropoxide and isopropanol in step a) before further processing. Diethanolamine, as a carrier substance, supports stable formation of the suspension, especially with simultaneous addition of (advantageously distilled) water.

Exemplary embodiments of the invention with additional design details and further advantages are described and explained in more detail below with reference to the accompanying drawings.

### BRIEF DESCRIPTION OF THE DRAWINGS

The invention is now described based on advantageous embodiments with reference to drawing figures, wherein:

FIG. 1 illustrates a perspective exploded view of an air purification unit according to the invention;

FIG. 2 illustrates a perspective sectional view of the first electric filter stage;

FIG. 3 illustrates a top view of the first and second electrodes of the first electric filter stage, which are in the form of plate electrodes, in the direction of arrow III in FIG. 2;

FIG. 4 illustrates a section of a first electrode of the plate electrode stack from FIG. 3 in the direction of view of arrow IV;

FIG. 5 illustrates a section of the plate electrode stack of FIG. 3 in the direction of view of arrow V with first and second electrodes shown in section;

FIG. 6 illustrates a process engineering diagram of a vehicle interior air purification system with an air purification unit according to the invention;

FIG. 7 illustrates an example of an air purification unit according to the invention provided with a shielding device for the electric filter module; and

FIG. 8 illustrates a flow diagram of a process according to the invention for the catalytic coating of electrodes for an air purification unit according to the invention.

### DETAILED DESCRIPTION OF THE INVENTION

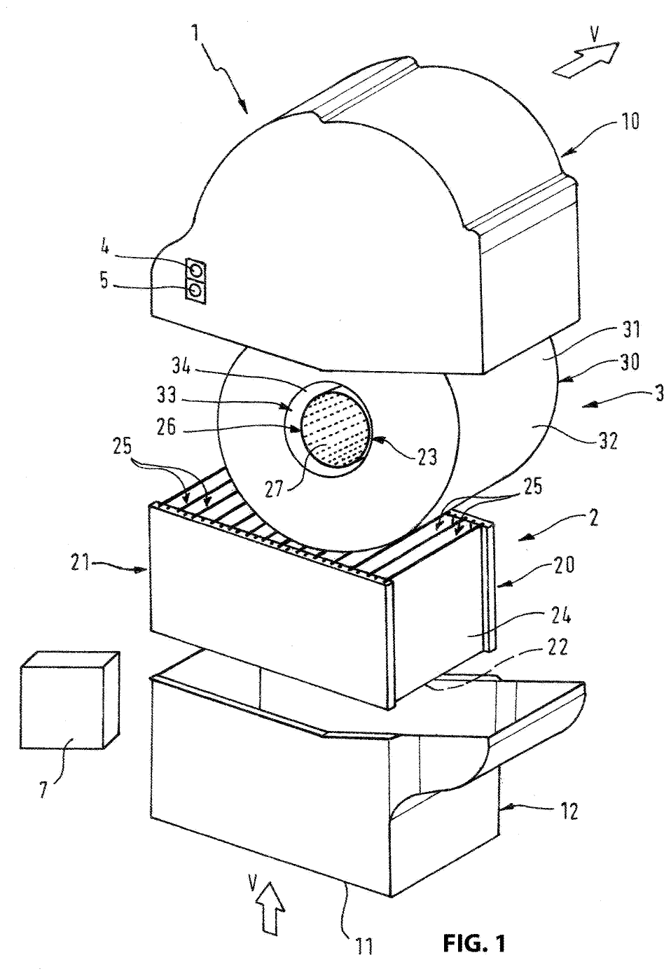

FIG. 1 shows an air purification unit 1 according to the invention with an upper housing 10 and a lower housing 12. The lower housing 12 has an air inlet 11 on its underside for the air to be purified, which is contaminated with pollutants and harmful particles and flows in the direction of flow V through the lower housing 12 and the upper housing 10 and the filters contained therein.

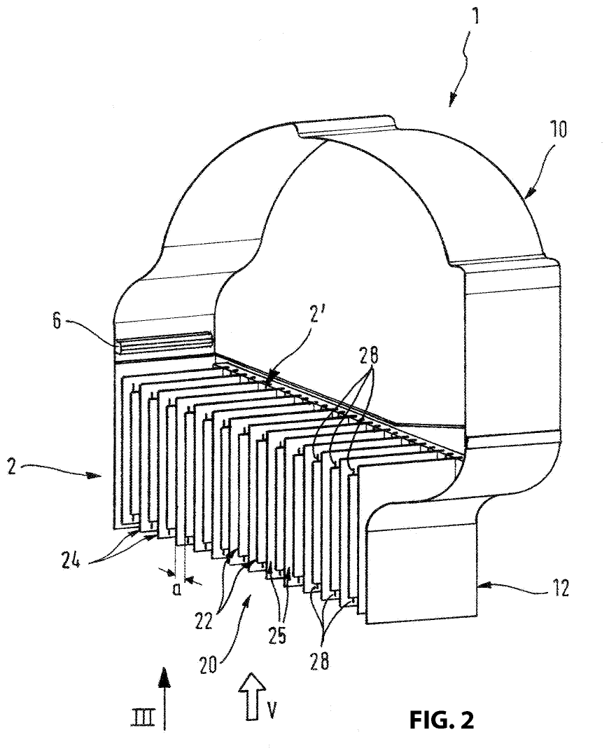

An ionizer 20 of an electric filter module 2 is arranged in the lower housing 12, forming a first electric filter stage 21 with first electrodes 22 (anodes) formed as plate electrodes and with second electrodes 24 (cathodes) formed as plate electrodes (FIG. 2).

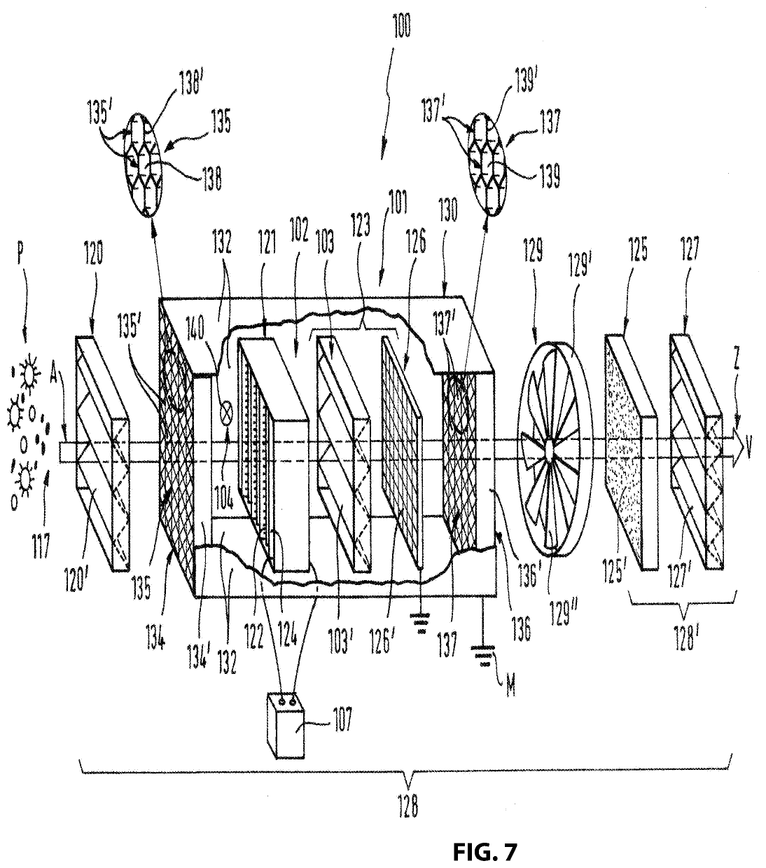

A mechanical filter module 3 with a mechanical filter element 30 designed as a HEPA filter 31, for example, is arranged in the upper housing 10. In the example shown, the mechanical filter module 3 is designed as an annular cylindrical filter cartridge with a radially outer inlet surface 32 for the air to be purified and an air outlet channel 33 designed as an inner exhaust air channel, the peripheral surface of which forms an outlet surface 34 for the purified air. The purified air flows back out through a side opening (not shown) in the upper housing 10, as symbolized by the arrow V. Instead of being a ring-cylindrical filter cartridge, however, the mechanical filter module 3 also can be designed differently, for example as a box-shaped filter module 103, as shown schematically in FIG. 7.

A ring-cylindrical third electrode 26, whose electrically conductive cylinder wall 27 forming the electrode surface is perforated or consists of a mesh or grid, is arranged inside the exhaust air duct 33 forming the air outlet channel. Together with the second electrodes 24 of the ionizer 20, the third electrode 26 forms a second electric filter stage 23.

Sensors 4, 5 are provided in the upper housing 10 for monitoring the ionization performance, for example, a sensor 4 for monitoring the amount of anions and a sensor 5 for monitoring the ozone content of the air downstream the ionizer.

In FIG. 2, the structure of the ionizer 20 is shown in a vertical section. The first electrodes 22, which are formed as plate electrodes, and the second electrodes 24, which are also formed as plate electrodes, are arranged alternately parallel to each other and laterally spaced apart from each other, with a respective plate gap 25 being formed between adjacent electrodes to form a passage for the air flow V of the air to be purified. The plurality of first electrodes 22 and second electrodes 24 arranged alternately in succession form a plate stack 2′ of the electric filter module 2. The first and the last electrodes of the plate stack 2′ are advantageously a second electrode 24 forming a cathode.

In the example shown, a row of UV light sources 6 (advantageously UVC light sources) is arranged in the upper housing 10 downstream of the ionizer 20 in flow direction V upstream of the mechanical filter 3. However, the provision of these additional UV light sources 6 is optional.

The first and second electrodes 22, 24 of the ionizer 20, which are in the form of plate electrodes, are connected via an electrically conductive connection, which is not shown, to a power supply module 7, which is in the form of a controllable high-voltage source and is shown only schematically in FIG. 1, which applies an electrical high voltage (DC voltage) of, for example, 3 kV to 10 kV to the first and second electrodes 22, 24 of the ionizer 20. The third electrode 26 is connected to electrical ground. A constant, lower DC voltage of, for example, 1000 V is applied between the second electrodes 24 of the ionizer 20 and the third electrode 26 provided inside the mechanical filter 3. Thus, an electrically positive voltage measured against ground is present at both the first electrodes 22 and the second electrodes 24, this positive voltage at the first electrodes 22 being higher than the positive voltage at the second electrodes 24.

Thus, despite the lower voltages than in conventional systems, there is a strong electric field (typically up to 900 kV/m) due to the relative potentials of the electrodes 22, 24 inside the ionizer 20 and a further, weaker field between the entire ionizer 20 and the third electrode 26 inside the mechanical filter 3, which accelerates the particles charged in the ionizer 20 towards the mechanical filter 3 and thus separates them there.

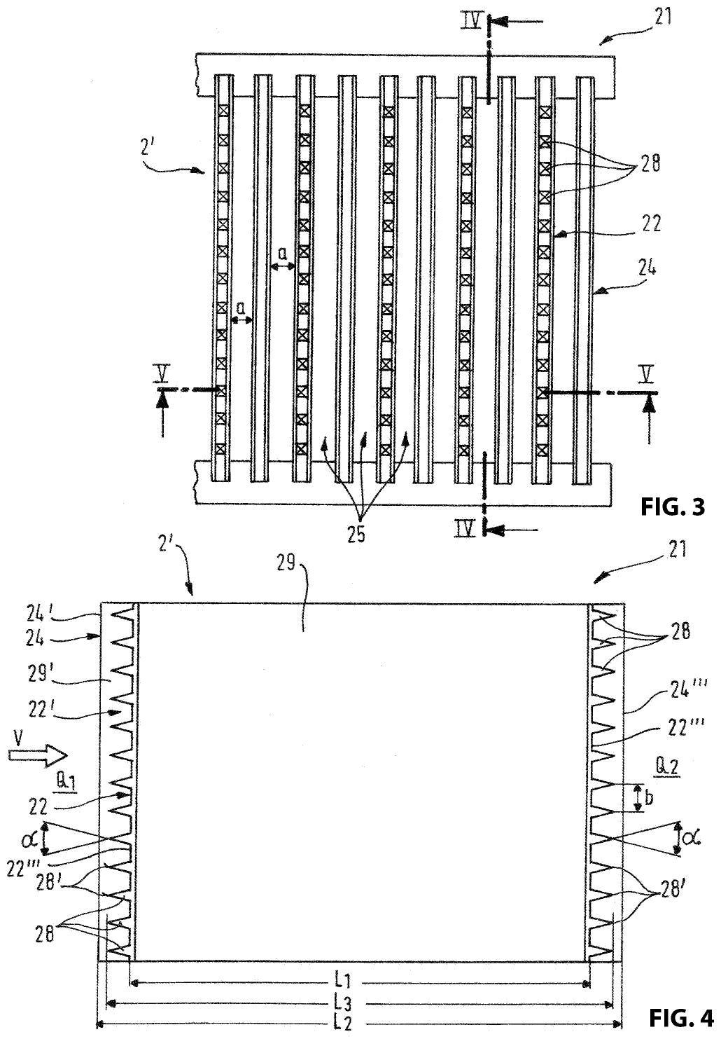

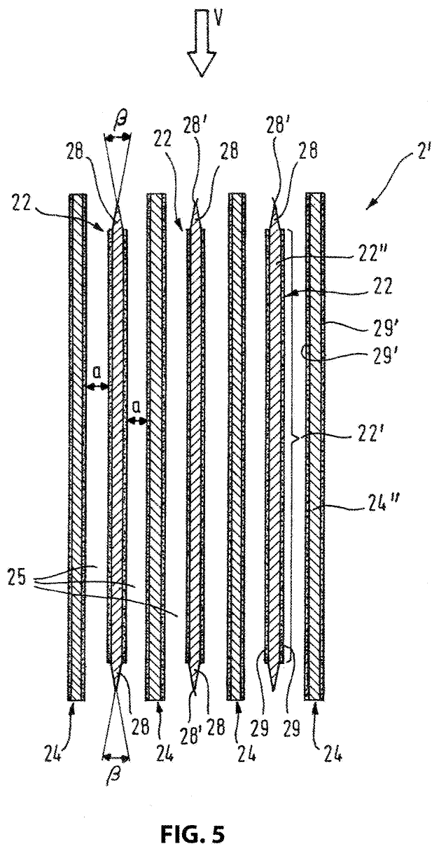

As can be seen in FIG. 2 and FIG. 4, the first electrodes 22 (anodes) each have a central plate section 22′ on which needle extensions 28, described further below, are formed (FIG. 4). The central plate sections 22′ of the first electrodes 22 are shorter in the direction of flow (V) of the air to be purified than the plates of the second electrodes 24, the longer plates of the second electrodes 24 projecting in the upstream direction and in the downstream direction respectively beyond the upstream and downstream plate edges 22″ of the central plate section 22′ in question and also beyond the tips 28′ of the needle extensions 28 of the adjacent first electrodes 22.

The electrically conductive needle extensions 28 are provided at the respective (in the direction of flow of the air to be purified) front edge and, in the example shown, also the rear edge of the shorter plate of the first electrodes 22 and thus extend in the downstream direction and, in the example shown, also in the upstream direction beyond the plate edge of the respective plate section 22′, but not as far as the height of the respective upstream edge 24′ or downstream edge 24″ of the longer second plate-like electrode 24. As a result, the points of highest electric field strength, namely the tips 28′ of the needle extensions 28 of the first electrodes 22 forming the anodes, are opposite the respective plate electrode surface of the adjacent second electrodes 24 forming the cathode. The length of the respective needle extension 28 is, for example, 0.7 times the plate spacing between adjacent first and second electrodes 22, 24.

In FIG. 3, the plate stack 2′ of the alternately arranged first electrodes 22 and second electrodes 24 of the first electric filter stage 21 designed as an ionizer is shown in a plane view in flow direction V of the air to be purified. It can be seen here that the first electrodes 22 are each provided over their entire height with a plurality of uniformly spaced needle extensions 28. The lateral spacing b of the mutually adjacent needle extensions 28 of a plate electrode (FIG. 4) is, for example, at least 1.5 times the plate spacing a between the mutually adjacent first and second electrodes 22, 24.

It can be clearly seen that the needle extensions 28 are formed on the first electrodes 22, which are shorter in the direction of flow V, and that the second electrodes 24 extend beyond the tips 28′ of the needle extensions 28 in the direction of flow V.

FIG. 4 shows a view of a first electrode 22 formed as an anode and a second electrode 24 located behind it, largely concealed, and formed as a cathode in the direction of arrow IV in FIG. 3. The first electrode 22 has the central plate section 22′, the length L₁ of which, measured in the direction of flow V, is shorter than the length L₂, measured in the direction of flow V, of the second electrode 24.

A plurality of electrically conductive needle extensions 28 extend from the central plate section 22′ both on the upstream air inlet side Q₁ and on the downstream air outlet side Q₂, which are integrally formed with the central plate section 22′ and together with the latter form the respective first electrode 22. The individual needle extensions 28 are laterally spaced apart from each other, and the tip angle α of each needle extension 28 measured in the plate plane is 39° in the example shown. The respective tips 28′ of the needle extensions 28 face the plate-like surface of the respective adjacent second electrode 24 and do not extend to the height of the respective edge 24′, 24″′ thereof, but are spaced therefrom, so that the total length L₃ of the first electrode 22 measured in the flow direction V between the respective tips 28′ of the needle extensions 28 is less than the length L₂ of the second electrode 24. The shorter first electrodes 22 measured between the respective tips 28′ of the needle extensions 28 (length L₃) are thereby shorter in relation to the longer plates of the second electrodes 24 (length L₂) on both sides in the direction of flow, i.e. both on the upstream air inlet side Q₁ and on the downstream air outlet side Q₂, by a dimension of approximately 2.5 to 3 times the lateral plate spacing a between two adjacent plate-like electrodes 22, 24. The plate spacing a can be between 7 mm and 14 mm, for example.

It can also be seen in FIG. 4 that the central plate portion 22′ of the respective first electrode 22 forming the anode is provided with a catalytic surface layer 29 extending over substantially the entire surface of the central plate portion 22′, but not provided on the surface of the needle extensions 28.

As can be seen in FIG. 5, which shows a sectional plane through the plate stack 2′ perpendicular to the drawing plane of FIG. 4, the first electrode 22 is coated with a catalytic surface layer 29 on each of its two large-area surfaces, each of which faces a second electrode 24, in the region of its central plate section 22′. This catalytic surface layer 29 preferably consists of titanium dioxide (TiO₂) or comprises titanium dioxide, advantageously in the form of nanoparticles, as will be explained further below. The large-area surfaces of the respective second, cathodic electrodes 24 are also provided with such a surface layer 29′ in the example shown, at least on the large-area surfaces facing one of the first electrodes 22, although it would be sufficient to provide only the surface layer 29 on the first, anodic electrodes 22.

The support material forming the core 22″ of the respective first electrode and the support material forming the core 24″ of the respective second electrode 24 are made of an electrically conductive material, for example a metal, advantageously titanium.

FIG. 5 also shows that the respective needle extensions 28 are also sharpened in the plane perpendicular to the plate plane shown in FIG. 4, the respective tip angle in the plane of FIG. 5, i.e. perpendicular to the plate plane, being 20° in the example shown.

Furthermore, it can be seen in FIG. 5 that the respective plate spacing a between the first electrodes 22 and the second electrodes 24 is the same over the entire width of the plate stack 2′ and in each case determines the width of a plate gap 25, which in each case forms a passage for the air flow.

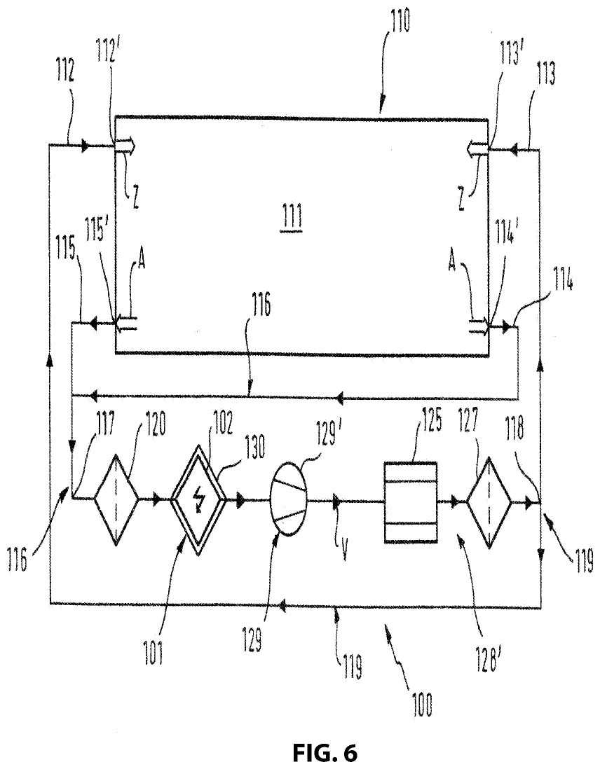

FIG. 6 shows schematically as a flow circuit diagram an example of an air purification system 100 comprising an air purification unit 101 according to the invention for an interior, using the example of a vehicle cab 110. However, the air purification unit 101 according to the invention can also be used as a mobile air purification system in the form of a mobile air purification device for building spaces, for example for living rooms, offices or classrooms in schools, for which the following explanations apply analogously.

The vehicle cabin 110, shown only schematically, for example the passenger cabin of an aircraft, a railroad car or a bus or a passenger ship, or even an elevator cabin of a building elevator, is provided with a plurality of air inlet ducts 112′, 113′ forming air inlets 112, 113 and air outlet ducts 114′, 115′ forming air outlets 114, 115.

Air from the interior 111 of the vehicle cabin 110 is exhausted through exhaust ducts 114, 115 and an exhaust duct system 116 connected thereto and supplied to a raw air inlet 117 of the air purification system 100.

The air purification system 100 has, downstream of the raw air inlet 117 in the flow direction V of the air to be purified, a mechanical prefilter module 120 with at least one filter medium 120′ (FIG. 7), with which coarser particles are removed from the air. For example, a mechanical coarse filter and/or a high-efficiency particulate air filter (HEPA filter) can be provided here as filter medium 120′. This is followed, in the flow direction V of the air to be purified, by the air cleaning unit 101 according to the invention with an electric filter module 102, which is preferably surrounded by a screening device 130 and corresponds in structure, for example, to the electric filter module 2 shown in FIGS. 1 to 5. The shielding device 130, described further below in connection with FIG. 7, shields the environment of the electric filter module 102 from electromagnetic pulses and forms an EMC shielding device 130.

Between the pre-filter module 120 and the air purification unit 101 with the electric filter module 102 or behind the air purification unit 101 with the electric filter module 102, an axial fan 129′ is provided as the air conveying device, the rotating air impeller 129″ of which causes the air to flow in the direction of flow V.

Downstream of the air purification unit 101 with the electric filter module 102 in the flow direction V, an adsorption filter module 125 with an activated carbon filter bed 125′ can be provided, in which in particular ozone is removed from the air. In addition to the activated carbon filter bed 125′ or instead of the activated carbon filter bed 125′, a molecular sieve filter can also be provided in the adsorption filter module 125, which can also remove chemical substances from the air and deposit them on the filter surface of the molecular sieve filter. If the mechanical filter module 103 included in the electric filter module 102 already includes an activated carbon filter bed in addition to the mechanical filter element 103′ designed as a HEPA filter, the adsorption filter module 125 may also be omitted.

Downstream of the adsorption filter module 125, a further mechanical filter module 127 can optionally be provided in flow direction V, which is designed as a HEPA filter and which has a filter medium 127′ that removes suspended matter still present in the air from the air. The filter medium 127′ of the further mechanical filter module 127 is also formed by a HEPA filter.

The purified air exiting the further filter module 127 then enters a supply air duct arrangement 119 connected to the supply air ducts 112, 113 from the clean air outlet 118 of the air purification device 100 and is returned to the vehicle cabin 110 as supply air Z.

The adsorption filter module 125 and the further mechanical filter module 127 form a filter unit 128′ for particle separation and/or for the separation of chemical air contaminants downstream of the electric filter module 102. This filter unit 128′ may preferably form an integral filter arrangement 128 together with the electric filter unit 3 and the prefilter module.

In the case of a mobile air purifier, the clean air outlet openings of the mobile air purifier directly opening into the room correspond to the clean air outlet of the air purification system, and the air inlet openings of the mobile air purifier for the air to be purified correspond to the raw air inlet of the air purification system.

FIG. 7 shows a schematic example of the individual components of an air purification system 100 with the air purification unit 101 according to the invention. This air purification system 100 has the mechanical prefilter 120 with the filter medium 120′ downstream of the unfiltered air inlet 117, i.e. downstream of the inlet of the exhaust air A from the vehicle cabin 110 which is contaminated with pollutant particles P, with which coarse particles are already removed from the air. This is followed, in the direction of flow V of the air to be purified, by the air cleaning unit 101 with the electric filter module 102 surrounded by the shielding device 130, namely the unit comprising the first electric filter stage 121 with the first electrodes 122 and second electrodes 124 and the second electric filter stage 123 with the mechanical filter module 103 and the third electrode 126.

The first electric filter stage 121 of the electric filter module 102 is constructed, like the first electric filter stage 21 of the electric filter module 2 in the example of FIGS. 1 to 5, from a plate arrangement comprising the plate-shaped first electrodes 122 and plate-shaped second electrodes 124 arranged alternately in a plate stack 2′, the first electrodes 122 being provided with needle extensions and forming the anodes, as in the example of FIGS. 1 to 5, and the second electrodes 124 forming the cathodes. The high electric voltage (DC voltage), which is provided by a power supply module 107 and can be varied in a controlled or regulated manner, is applied to the first electrodes 122 and second electrodes 124. To avoid repetition, reference is therefore made to the description of FIGS. 1 to 5. Also with regard to the structure and design of the mechanical filter module 103 provided downstream of the first electric filter stage 121 in the direction of flow V of the air and of the third electrode 126 of the second electric filter stage 123, which is assigned to the latter and is connected to the electrical ground M, reference is made to the description of FIGS. 1 to 5 in order to avoid repetitions, it being possible for the mechanical filter module 103 to be of tubular-cylindrical design, as in the example of FIGS. 1 to 5, or alternatively to be designed as a rectangular block-shaped mechanical filter module 103 through which air flows longitudinally, as shown in FIG. 7. In such a rectangular block-shaped filter module 103, the third electrode — as in the example of FIGS. 1 to 5—is provided either inside the filter module 103 or (as shown in FIG. 7) in the area of its surface on the exhaust side, for example as a grid electrode 126′.

The shielding device 130 designed as a high-frequency shielding device represents an EMP (electromagnetic pulse) shielding device and has a circumferential shielding wall 132 made of an electrically conductive material or a material with an electrically conductive surface, which surrounds the electric filter module 102 with the mechanical filter module 103, i.e. the first electric filter stage 121 and the second electric filter stage 123, and is impermeable to high-frequency radiation (HF), and is electrically conductively connected to an electrical ground M of the electric filter module 102. In a modified embodiment suitable for lower shielding requirements, only the first electric filter stage 121 is surrounded by the shielding means 130.

In front of the air inflow side and behind the air outflow side of the electric filter module 102, a block-type shielding module through which the air can flow is provided in each case, namely an inflow-side shielding module 134 and an outflow-side shielding module 136, each of which is connected in an HF-tight manner to the circumferential shielding wall 132.

The respective shielding module 134, 136 through which the air can flow has in each case a frame 134′, 136′ made of an electrically conductive material or of a material having an electrically conductive surface, which frame is connected in an HF-tight manner to the circumferential shielding wall 132 and which is likewise connected in an electrically conductive manner to the electrical ground M of the electric filter module 102 A honeycomb panel 135, 137 is mounted in the respective frame 134′, 136′, the individual honeycombs 135′, 137′ of which are open at both ends thereof and each form an air passage channel 138, 139 having a channel wall 138′, 139′ as shown in the respective enlarged cutaway view. The length of the individual air passage channels 138, 139 is several times greater than their respective cross-sections, so that the air passage channels 138, 139 each form a tube of hexagonal cross-section.

The respective honeycomb panel 135, 137 includes either of an electrically conductive material, advantageously aluminum or an aluminum alloy, or it includes electrically non-conductive material, advantageously paper, cardboard or a plastic, as a carrier material, the surface of which is provided, advantageously coated, at least in areas with an electrically conductive material. The respective honeycomb panel 135, 137 is also connected in an electrically conductive and RF-tight manner to the associated frame 134′, 136′ of the respective shielding module 134, 136.

In addition, in the example shown, a UV filter module 104 is optionally provided within the air purification unit 101, which is shown only schematically in FIG. 7 as a UV light source 140. Multiple UV light sources may also be provided distributed around the circumference and in the axial direction. The UV filter module 104 with its at least one UV light source may also be integrated into the electric filter module 102.

It is also advantageous if fresh air (ambient air) drawn in from outside the vehicle cabin is not fed directly into the vehicle cabin, but is mixed with the cabin air to be filtered and is first passed with it through the air purification unit 101, since the electric filter module 102 is able, due to the catalytic surface coating of the electrodes with titanium oxide, to break down any volatile organic hydrocarbons and hydrocarbon compounds (VOCs) contained in the fresh air drawn in and to decompose them into shorter-chain hydrocarbon compounds, thus breaking down the VOCs contained in the air.

The ambient air thus introduced into the aircraft cabin, for example, in an aircraft for the purpose of building up cabin pressure from a higher compressor stage of an engine of the aircraft is consequently introduced into the air stream flowing in flow direction V upstream of the prefilter module 120 or upstream of the air purification unit 101 and mixed with the air flowing there. In the air purification unit 101 then flowing through, hydrocarbons are thus also removed from the ambient air supplied by the electric filter module 102. This prevents, for example, impurities (particles or gases) drawn in during stationary operation of the vehicle, in particular of an aircraft, from being dispersed in the vehicle cabin.

The modules shown in FIG. 7, pre-filter 120, air purification unit 101 with the electric filter module 102 and, if applicable, the adsorption filter module 125 and the—if present—further filter module 127, can advantageously be combined as an integral filter arrangement 128.

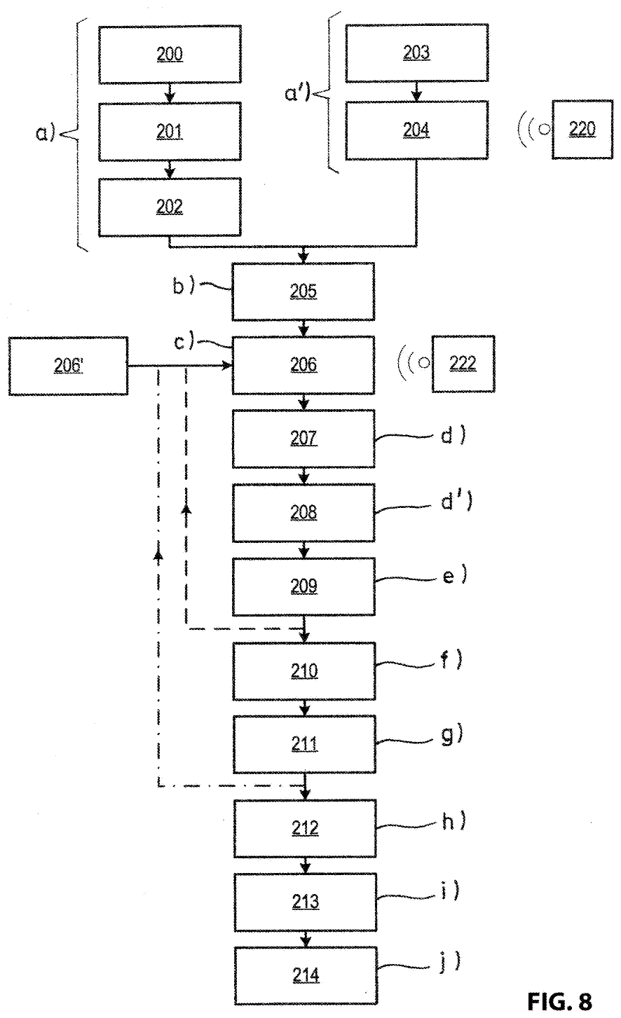

FIG. 8 shows a flow diagram of a process according to the invention for coating an electrode 22, 24, in particular an anode 22, of an air purification unit according to the invention with a catalytic surface layer 29, 29′ comprising titanium oxide nanoparticles, as shown in the example of FIGS. 4 and 5.

First, a solution of titanium isopropoxide (C₁₂H₂₈O₄Ti), abbreviated as TTIP and also referred to as tetraisopropyl orthotitanate or tetraisopropyl titanate, in isopropanol (C₃H₈O) is prepared in step 200 and then made available for further processing (process step a). Advantageously, this solution is a 0.5 molar solution of titanium isopropoxide in isopropanol.

It is particularly advantageous if diethanolamine (C₄H₁₁NO₂), abbreviated as DEA, is added to this solution in step 201, preferably until the molar ratio of DEA to TTIP is 4. Then, advantageously in step 202, this mixture is stirred for a predetermined period of time, for example for two hours, at room temperature (about 20° C.) and then made available for further processing. Advantageously, distilled water can still be added to the mixture while stirring.

Furthermore, a suspension of titanium oxide nanoparticles in isopropanol (C₃H₈O) is prepared and made available—in parallel or consecutively (process step a′). For this purpose, in step 203 titanium oxide nanoparticles, advantageously titanium dioxide nanoparticles, are added to the liquid isopropanol with constant stirring, for example in a ratio of 50 g (grams) of nanoparticles to 1,000 ml (milliliters) of isopropanol. The size of the nanoparticles is advantageously 50 μm or less.

This suspension is then subjected to ultrasonic vibrations by an ultrasonic generator 220 for a predetermined period of time, such as one hour, in step 204 to achieve uniform distribution of the nanoparticles in the suspension and to prevent sedimentation thereof.

Subsequently, in step 205, the solution of TTIP and isopropanol and optionally DEA obtained in process step a) is mixed together, while being stirred, with the suspension of titanium oxide nanoparticles in isopropanol obtained in process step a′) to form a suspension immersion bath (process step b).

In step 206, the electrodes to be coated, which have previously been degreased, dried and heated to a temperature of 105° C. in step 206′ and in which the areas not to be coated (for example the needle extensions 28) have been covered, are immersed in this suspension immersion bath for a predetermined immersion period (for example for five minutes) (process step c). In this process, it is advantageous if the suspension immersion bath is subjected to ultrasonic vibrations by an ultrasonic generator 222 to prevent agglomeration of the nanoparticles.

After the electrodes have been drawn out from the suspension immersion bath in step 207 (process step d), the suspension liquid still adhering to the coated electrodes is advantageously first allowed to drip off in step 208 for a predetermined dripping period (for example for 10 minutes) (process step d′) and then dried in step 209 for a first predetermined drying period at room temperature, for example for 12 hours (process step e).

Thereafter, in step 210, the coated electrodes are heated to an elevated drying temperature of about 100° C. at a predetermined first heating temperature gradient of advantageously 3° C./min (process step f).

Subsequently, in step 211, the heated coated electrodes are dried for a second predetermined drying period of advantageously one hour at the elevated drying temperature (process step g).

The coated electrodes dried in this way are then heated in step 212 with a predetermined second heating temperature gradient, which is advantageously also 3° C./min, to an input firing temperature of about 500° C. (process step h) and then baked in step 213 for a predetermined baking period of advantageously one hour at a predetermined baking temperature of, for example, 650° C. (process step i). After completion of this baking process, the baked electrodes are finally cooled to room temperature in step 214 for a predetermined cooling period of, for example, 12 hours (process step j).

In order to achieve a catalytic coating that is effective for as long and as durable as possible, steps 206 to 209 or 206 to 211 are repeated once or several times, as symbolized by the dashed line and the dash-dotted line, respectively, in FIG. 7. In one variant of the process according to the invention, four repetitions, i.e. five immersions, have proved advantageous.

Reference numerals in the description and the drawings serve only for a better understanding of the invention and are not intended to limit the scope of protection.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

### REFERENCE NUMERALS AND DESIGNATIONS

1 air purification unit
2 electric filter module
2′ plate stack
3 mechanical filter module
4 sensor for monitoring the amount of anions
5 sensor for monitoring the ozone content
6 UV light source
7 power supply module
10 upper housing
11 air intake
12 bottom housing
20 ionizer
21 first electric filter stage
22 first electrodes
22′ central plate section of 22
22″ core from 22
23 second electric filter stage
24 second electrodes
24′ air inlet side (upstream) edge of 24
24″ core from 24
24″′ air outlet side (downstream) edge of 24
25 plate gap
26 third electrode
27 cylinder wall
28 needle extension
28′ tip from 28
29 catalytic surface layer of 22
29′ catalytic surface layer of 24
30 mechanical filter element
31 suspended matter filter
32 radial outer inlet surface
33 air outlet duct
34 outlet area
100 vehicle interior air purification system
101 air purification unit
102 electric filter module
103 mechanical filter module
103′ mechanical filter element
104 UV filter module
107 power supply module
110 vehicle cabin
112 supply air ducts
112′ air influences
113 supply air ducts
113′ air inlets
114 exhaust air duct
115 exhaust duct
116 exhaust duct system
117 pipe air inlet
118 clean air outlet
119 supply air duct arrangement
120 mechanical prefilter module
120′ filter medium
121 first electric filter stage
122 first electrodes
123 second electric filter stage
124 second electrodes
125 adsorption filter module
125′ activated carbon filter bed
126 third electrodes
126 grid electrode
127 mechanical filter module
127′ filter medium
128 integral filter arrangement
128′ filter unit
129 air conveyor
129′ axial blower
129″ air impeller
130 shielding device
132 circumferential shield wall
134 inflow-side shielding module
134′ frame
135 honeycomb panel
135′ honeycomb
136 downstream shielding module
136′ frame
137 honeycomb panel
137′ honeycomb
138 air passage duct
138′ duct wall
139 air passage duct
139′ duct wall
220 ultrasonic generator
222 ultrasonic generator
A exhaust air of the vehicle cabin
Q₁ air inlet side
Q₂ air outlet side
L₁ length from 22′
L₂ length from 24
L₃ length from 22
M mass
P pollutant particles
V flow direction
Z supply air
A plate spacing
B distance between the tips 28′ of adjacent needle extensions 28
α tip angle
β tip angle

What is claimed is:

1. An air purification unit, comprising:
at least one electric filter module configured to be flowed through by air to be purified and including at least one first electrode and at least one second electrode,
wherein the air to be purified flows between the at least one first electrode and the at least one second electrode,
wherein a first electric field is generatable between the at least one first electrode and the at least one second electrode by applying a high electric voltage provided by a power supply module, and
wherein the at least one first electrode and the at least one second electrode form an ionizer;
a mechanical filter module including at least one mechanical filter element arranged downstream of the electric filter module in a direction of a flow of the air to be purified;
at least one third electrode provided in the mechanical filter element or in the mechanical filter module downstream of the mechanical filter element,
wherein a second electric field is generatable between the at least one second electrode and the at least one third electrode by applying an electric voltage.

2. The air purification unit according to claim 1, wherein the at least one first electrode and the at least one second electrode are configured as plate electrodes.

3. The air purification unit according to claim 2, wherein surfaces of the at least one first electrode or of the at least one second electrode are provided at least partially with a catalytic surface layer including titanium oxide.

4. The air purification unit according to claim 3,
wherein the at least one first electrode configured as a plate electrode is shorter in the direction of the flow of the air to be purified than the at least one second electrode configured as a plate electrode, and
wherein the at least one second electrode protrudes beyond the at least one first electrode in the downstream direction or in an upstream direction.

5. The air purification unit according to claim 3,
wherein the at least one first electrode includes a plate portion which includes at least one electrically conductive needle extension arranged essentially in a plate plane of a plate section and that extends in the downstream direction or in the upstream direction beyond a plate edge of the plate section of the at least one first electrode.

6. The air purification unit according to claim 5, wherein the at least one needle extension tapers towards a needle tip in two planes orthogonal to one another.

7. The air purification unit according to claim 5, wherein no surfaces of the at least one needle extension are provided with the catalytic surface layer.

8. The air purification unit according to claim 1,
wherein the at least one third electrode is connected to an electrical ground,
wherein an electrically positive voltage measured to electrical ground is present both at the at least one first electrode and at the at least one second electrode, and
wherein the positive voltage at the at least one first electrode is higher than the positive voltage at the at least one second electrode.

9. The air purification unit according to claim 1,
wherein a controllable DC voltage is applied between the at least one first electrode and the at least one second electrode during operation, and wherein a constant DC voltage is present between the at least one second
electrode and the at least one third electrode during operation.

10. The air purification unit according to claim 1,
wherein at least one sensor configured to monitor an ozone content of the air to be purified is provided downstream of an arrangement including the at least one first electrode and the at least one second electrode in the flow direction of the air to be purified.

11. The air purification unit according to claim 1,
wherein at least one sensor configured to monitor an amount of anions is provided downstream of an arrangement including the at least one first electrode and the at least one second electrode in the flow direction of the air to be purified.

12. The air purification unit according to claim 1, wherein a level of the electrical voltage which is applied between the at least one first electrode and the at least one second electrode is determined dynamically by a closed-loop control.

13. The air purification unit according to claim 1,
wherein the at least one electric filter module is enveloped by a shielding device and forms an electric filter unit together with the shielding device,
wherein at least one shielding module is provided that is flowable by the air to be purified and arranged upstream or downstream of the at least one electric filter module in the direction of flow of the air to be purified and which includes a plurality of air passage elements which each define an air passage channel surrounded by a channel wall,
wherein the at least one shielding module that is flowable by the air to be purified includes at least one honeycomb panel,
wherein individual honeycombs of the honeycomb panel are open at both ends thereof and each form one of the air passage channels, and
wherein a respective channel wall of the air passage channels is electrically conductive or has an electrically conductive surface.

14. A method for coating an electrode according to claim 3 with a catalytic surface layer including titanium oxide, the method comprising:
a) providing a solution of titanium isopropoxide in isopropanol;
a′) providing a suspension of titanium oxide nanoparticles in isopropanol and subjecting the suspension to ultrasonic vibrations;
b) mixing the solution obtained in step a) with the suspension obtained in step a′) to form a suspension immersion bath;
c) immersing the electrode to be coated into the suspension immersion bath for a predetermined immersion time period;
d) pulling the coated electrode out of the suspension immersion bath;
e) drying the coated electrode for a first predetermined drying period at room temperature;
f) heating the coated electrode with a predetermined first heating temperature gradient up to an elevated drying temperature;
g) drying the coated electrode for a second predetermined drying period at the elevated drying temperature;
h) heating the coated electrode with a predetermined second heating temperature gradient up to an input firing temperature;
i) firing the coated electrode for a predetermined firing time period at a predetermined firing temperature; and
j) cooling the fired coated electrode down to room temperature for a predetermined cooling time period.

15. The method according to claim 14, further comprising:
adding diethanolamine to the solution of titanium isopropoxide and isopropanol in step a) before further processing.

16. A method for coating an electrode according to claim 3 with a catalytic surface layer including titanium oxide, the method comprising:
a) providing a solution of titanium isopropoxide in isopropanol;
a′) providing a suspension of titanium oxide nanoparticles in isopropanol and subjecting the suspension to ultrasonic vibrations;
b) mixing the solution obtained in step a) with the suspension obtained in step a′) to form a suspension immersion bath;
c) immersing the electrode to be coated into the suspension immersion bath for a predetermined immersion time period; and
d) pulling the coated electrode out of the suspension immersion bath.
